(19) United States
(12) Patent Application Publication
(10) Pub. No.: US 2019/0052588 A1
(43) Pub. Date: Feb. 14, 2019

(54) SYSTEM FOR SHARING MEDIA FILES

(71) Applicants: SANJAY ROHATGI, SARATOGA, CA (US); NISHAD ABDUL RAHIMAN, PERUMBILAVU (IN); UDAYAN SAHU, SAN RAMON, CA (US)

(72) Inventors: SANJAY ROHATGI, SARATOGA, CA (US); NISHAD ABDUL RAHIMAN, PERUMBILAVU (IN); UDAYAN SAHU, SAN RAMON, CA (US)

(73) Assignee: PICME, INC., SARATOGA, CA (US)

(21) Appl. No.: 16/159,648

(22) Filed: Oct. 13, 2018

Related U.S. Application Data
(63) Continuation-in-part of application No. 16/139,071, filed on Sep. 23, 2018.

(51) Int. Cl. H04L 12/58; G06K 9/00

(52) U.S. Cl. CPC H04L 51/08; G06K 9/00288; H04L 51/32

(57) ABSTRACT

A media file is shared by a user by first registering with a media-sharing-server. Upon registration, the user submits facial recognition images, which are used by the media-sharing-server to identify received media files that pertain to that user. Other users also register and agree to share media by conveying to the media-sharing-server media files created upon capturing images or audio.

### RELATED APPLICATIONS

The present application claims priority to U.S. Provisional Application Ser. No. 62/551,552 filed on Jun. 26, 2018 and entitled “SYSTEM FOR SHARING MEDIA FILES”, by Sanjay Rohatgi, et. al, and to U.S. application Ser. No. 16/139,071 filed on Sep. 23, 2018 and entitled “SYSTEM FOR SHARING MEDIA FILES”, by Sanjay Rohatgi, et. al, the text and figures of each of these applications is incorporated by reference into this application in their entireties.

### BACKGROUND

Today, just about everyone has the ability to take a snapshot or even capture video using a pocket multi-media device. A very common form of such a multi-media device is a cellular telephone that embodies a processor, a memory, and an image capture device. It should be appreciated that the image capture device, according to various embodiments of prior art, can be used to capture a still image or moving images.

In fact, the ability to take pictures or capture video is so prolific that a new problem has arisen. Most people simply cannot manage their captured media for themselves. And, many people cannot effectively share pictures or video with people unless they are part of their social network.

There are numerous prior art applications for sharing photos that are designed to be executed on a multi-media device, for example a smart phone. For example, Vasquez-Fernandez et al. has described an application that is capable of identifying people in an image using facial recognition technology. By using facial recognition, Vasquez-Fernandez has taught us that, with continued interaction with a user, an application can create a library of associated users. This, however, requires that everyone in a user's personal contact database be associated with a facial image. The facial image is then later used to identify subjects in a picture. This, of course, requires additional management on behalf of each user.

According to Vasquez-Fernandez, images that are subject to facial recognition can be associated with a facial image and further associated with a contact record stored in a mobile device. Once a subject is identified in an image, that image can be sent to the subject using an email address provided in the user's personal contact database. If any one of these critical data elements is missing from the user's personal contact database, an image simply cannot be shared. Hence, according to Vasquez-Fernandez, it is important to maintain and manage reference images in association with records included in a user's personal contact database. This management further extends to maintaining valid email addresses for each contact in the user's personal contact database. This is hardly simple, and is not efficient from a user's perspective.

A photo sharing system has also been described in U.S. Pat. No. 8,655,028 issued to Hsi on Feb. 18, 2014. Hsi describes similar photo sharing capabilities whereby each user creates and maintains a “face address book”. Again, the user is tasked with maintaining facial images for reference purposes in association with names and photo sharing delivery indicators. Email accounts, mobile phone numbers and Facebook accounts are also associated with contacts stored in a user's personal database for this purpose.

Hsi again fails to recognize the burden imposed on individual users by his photo sharing system. Hsi, just as described by Vasquez-Fernandez, requires users to associate images in pictures with contacts stored in their personal contact database. Hsi's photo browser is an application that remains resident on a user's mobile device and which is used to associate facial images in photographs with contacts in the users contact database. This manual and tedious association process results in a face address book, depicted by Hsi in FIG. 4.

Vasquez-Fernandez recognized that, by using a photo sharing application on a mobile device, facial signatures could be derived from images in a media file. These facial images, according to Vasquez-Fernandez, could then be associated with contact information, which is also stored in the mobile device. Vasquez-Fernandez uses the term “registering subjects” to refer to this association process. Vasquez-Fernandez and Hsi both recognize the need to associate facial signatures with contact information. Based on this type of association, photos could be shared by individual users. The photo sharing application of Vasquez-Fernandez is analogous to the photo browser described by Hsi. In each case, a user, using a mobile device, needs to associate a facial image with a contact already stored in that user's mobile device.

### BRIEF DESCRIPTION OF THE DRAWINGS

Several alternative embodiments will hereinafter be described in conjunction with the appended drawings and figures, wherein like numerals denote like elements, and in which:

FIG. 1 is a system diagram that depicts one example embodiment of a system for sharing media files;

FIG. 2 is a block diagram of one example embodiment of a media-sharing-server included in one example embodiment of a system for sharing media files;

FIG. 3 is a data flow diagram that illustrates the internal operation of various alternative example embodiments of a media sharing server;

FIG. 4 is a pictorial diagram that depicts alternative example embodiments of user tables maintained by various embodiments of a system for sharing photos;

FIG. 5 is a data flow diagram that depicts alternative example embodiments of a system for sharing a media file that correlates an apparel article or an accessory article with a particular facial signature;

FIG. 6 is a pictorial diagram that illustrates the operation of yet another alternative example embodiment of a signature module;

FIG. 7 is a data flow diagram that illustrates the internal operation of one alternative example embodiment of a media-sharing-server;

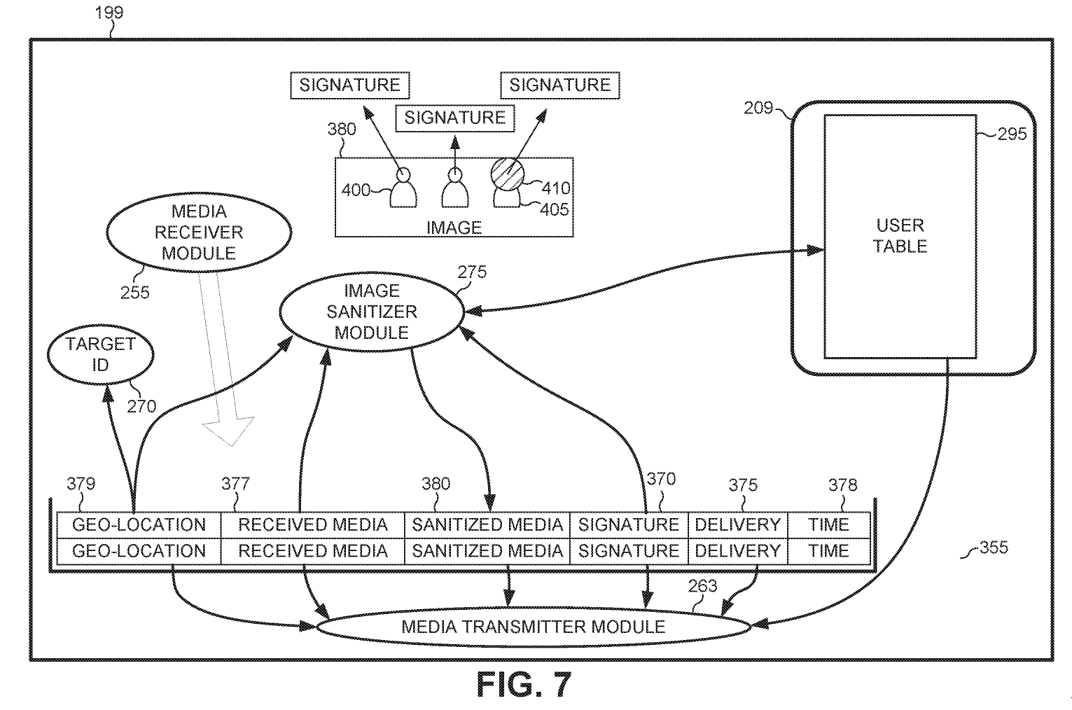

FIG. 8 is a data flow diagram that depicts the operation of the processor as it executes one example embodiment of an acquaintance module;

FIG. 9 is a data flow diagram that depicts the operation of the processor when executing one example embodiment of a learning module; and

FIG. 10 is a data flow diagram that depicts the operation of the processor as it executes an alternative embodiment of the learning module.

### DETAILED DESCRIPTION

As used through the remainder of this disclosure, the term “registration” and variants thereof is drastically different than the term “registering subjects” as used by Vasquez-Fernandez. In this disclosure, registration pertains to registering individual users with a media sharing server. As will become apparent through the disclosures presented herein, a user is an individual desirous of obtaining media pertaining to their own person. Most importantly, the present system ensures that all users that register with a media-sharing-server will receive media pertaining to their own person irrespective of whether someone intended to share the media with them. Registration, according to various embodiments, is affected through a web page served by the media-sharing-server or by down-loading an application and using a registration function provided thereby.

Registration, according to another example embodiment, is accomplished by way of instant messaging service. In this example embodiment, a user sends a registration picture to a media-sharing-server. When the media-sharing-server receives a registration picture by way of an instant messaging service, it identifies a particular user according to source information provided by the instant messaging service. The source information is then used as a destination indicator when sharing media. Accordingly, when sharing a multimedia file with a user, said user being identified by such sourcing information, the sourcing information is then used as a destination indicator and media is then shared using the same instant messaging service.

It should be appreciated that, according to various illustrative use cases, the instant messaging service comprises at least one or more of a multimedia-message-service, “what's app” instant messaging, Facebook instant messaging, Google instant messaging, Yahoo instant messaging, “LINE” instant messaging, Twitter instant messaging, snap chat instant messaging, and/or Kakoa talk instant messaging. It should be appreciated that these example illustrative use cases are not intended to limit the scope of the claims appended hereto.

Accordingly, one distinguishing feature of the system presented herein is that, once a person registers with the media-sharing-server, that user receives media pertaining to their own person from all other users registered with the media-sharing-server. Individual users need not specify which media is to be shared with other users, thereby drastically reducing the workload on individual users and increasing overall system efficacy. In some embodiments, users that take pictures are provided with the capability to specify which pictures should be shared or in the alternative, which pictures should not be shared.

In the interest of clarity, several example alternative methods are described in plain language. Such plain language descriptions of the various steps included in a particular method allow for easier comprehension and a more fluid description of a claimed method and its application. Accordingly, specific method steps are identified by the term “step” followed by a numeric reference to a flow diagram presented in the figures, e.g. (step 5). All such method “steps” are intended to be included in an open-ended enumeration of steps included in a particular claimed method. For example, the phrase “according to this example method, the item is processed using A” is to be given the meaning of “the present method includes step A, which is used to process the item”. All variations of such natural language descriptions of method steps are to be afforded this same open-ended enumeration of a step included in a particular claimed method.

Unless specifically taught to the contrary, method steps are interchangeable and specific sequences may be varied according to various alternatives contemplated. Accordingly, the claims are to be construed within such structure. Further, unless specifically taught to the contrary, method steps that include the phrase “ . . . comprises at least one or more of A, B, and/or C . . . ” means that the method step is to include every combination and permutation of the enumerated elements such as “only A”, “only B”, “only C”, “A and B, but not C”, “B and C, but not A”, “A and C, but not B”, and “A and B and C”. This same claim structure is also intended to be open-ended and any such combination of the enumerated elements together with a non-enumerated element, e.g. “A and D, but not B and not C”, is to fall within the scope of the claim. Given the open-ended intent of this claim language, the addition of a second element, including an additional of an enumerated element such as “2 of A”, is to be included in the scope of such claim. This same intended claim structure is also applicable to apparatus and system claims.

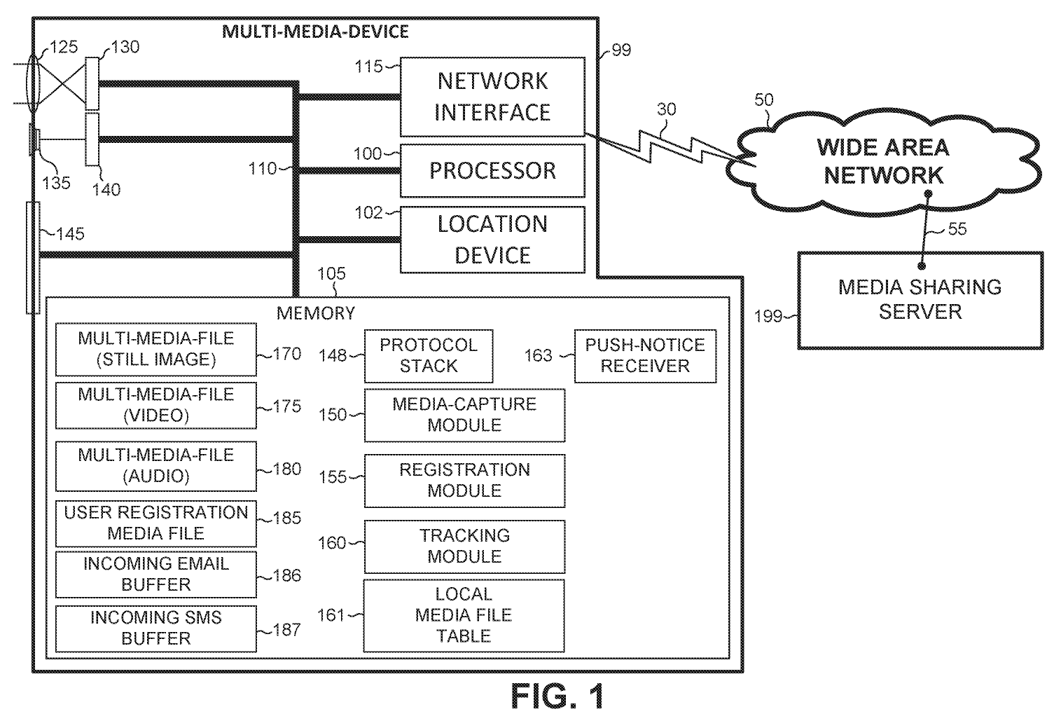

FIG. 1 is a system diagram that depicts one example embodiment of a system for sharing media files. It should be appreciated that, according to one illustrative use case, the system described here is utilized in conjunction with a multi-media-device 99. According to various illustrative use cases, the multi-media-device 99 comprises at least one of a cellular telephone, a cellular smart phone, a tablet, a notebook computer and any device capable of taking pictures and video with ability to connect to a communications network. It should likewise be appreciated that, according to other various illustrative use cases, the multi-media-device 99 comprises at least one of a smart camera and a smart video camera, which are described as a cameras having a processor, memory, and network access capabilities.

FIG. 1 illustrates that a multi-media-device 99 includes at least one of an image capture device 130, which is also referred to as a camera-element. In at least one alternative illustrative embodiment, the image capture device 130 is used with an included focusing element 125. It should likewise be appreciated that the focusing element 125 is used to collect optical information and focus it upon the image capture device 130. In this embodiment of a multi-media-device 99, the image capture device 130 is coupled to an internal bus 110. This example embodiment of a multi-media-device 99 includes a processor 100, a memory 105, a network interface 115, and a graphical user interface 145. One alternative example embodiment of a multi-media-device 99 further includes a location device 102. The foregoing elements are also coupled to the internal bus 110. The internal bus 110 serves as a communication pathway that ensures all multi-media-device components are able to communicate with each other.

FIG. 1 also illustrates that the network interface 115 included in the multi-media-device 99 provides for communication 30 with a wide area network 50. In turn, the wide area network provides a communication path 55 with a media-sharing-server 199 included in one embodiment of a system for sharing media. It should be appreciated that the network interface 115 comprises at least one or more of a wired interface and a wireless interface. In the case of a wired interface, the interface includes at least one of an Ethernet interface, a FireWire interface, and/or a fiber dated distributed interface. These example interfaces are not intended to limit the scope of the claims appended hereto. In the case of a wireless interface, the wireless interface comprises at least one or more of a Bluetooth wireless interface, and/or a Wi-Fi interface. In yet another alternative embodiment, the wireless interface comprises a cellular data carriage, which is commonly included in a cellular telephone. These various illustrative embodiments are intended to aid a reader comprehend the innovations herein described and are not intended to limit the scope of the claims appended hereto.

Further included in a user's multi-media-device 99 are various functional modules, each of which comprises an instruction sequence. For purposes of this disclosure, a functional module and its corresponding instruction sequence is referred to by a process name, a function name or a module name, each of which may be used interchangeably.

The reader is advised that the term “minimally causes the processor” and variants thereof is intended to serve as an open-ended enumeration of functions performed by a processor as it executes a particular functional process (i.e. instruction sequence). As such, an embodiment where a particular functional process causes the processor to perform functions in addition to those defined in the appended claims is to be included in the scope of the claims appended hereto.

It should be appreciated that, according to various illustrative use cases, a multi-media-device 99 includes some form of image capture software, which is operated by a user and which, when executed by the processor 100 included in the multi-media-device 99, minimally causes that processor 100 to capture an image using the image capture device 130 and to store the resulting image in a media file 170, said media file being stored in the memory 105.

According to one alternative illustrative use case, the processor 100 included in the multi-media-device 99, as it executes an image capture application stored in its memory 105, captures moving images in the form of video and stores this in a multi-media video file 175. In some embodiments, the processor 100, as it executes an image capture application stored in its memory 105, captures moving images using the image capture device 130 along with audio using a microphone 135 and an audio codec 140.

In yet other various alternative use cases, the processor 100 included in the multi-media-device 99, as it executes an image capture application stored in its memory 105, captures audio using a microphone 135 and an audio codec 140, both of which are included in one alternative example embodiment of a multi-media-device 99. Audio captured using the microphone 135 is then stored in a multi-media-device audio file 180.

One alternative example embodiment of a multi-media-device 99 includes a protocol stack 148. According to one alternative example use case, the processor 100 is further minimally caused to execute the protocol stack 140 stored in the memory 105. By executing the protocol stack 148, the processor 100 establishes an upload connection with a media-sharing-server 199, said media-sharing-server being included in this example system embodiment. It should be appreciated that the upload connection is established using the network interface 115 in order to communicate 30 with the media-sharing-server 199 by way of a wide area network 50.

It should be appreciated that, according to one illustrative use case, the user executes the image capture module in order to capture an image from the camera element 130 and store the image in the memory 105. In another illustrative use case, the user executes the image capture module to capture video from the camera element 130 and store the video in the memory 105. And in yet another illustrative use case, the user executes the image capture module to capture audio from the audio codec 140 and store the audio in the memory 105. In any of these illustrative use case, the user captures a multi-media file in the form of a still image 170, a video 175, and/or an audio file 180.

According to various illustrative use cases, the user then conveys the captured multi-media file to the media-sharing-sever by way of a communication connection established by the processor 100 in the multi-media-device 99. This occurs when the user initiates a multi-media-file upload to the media-sharing-server. According to another collection of illustrative use cases, the user sends a multi-media file to the media-sharing-sever by way of a messaging system as heretofore described.

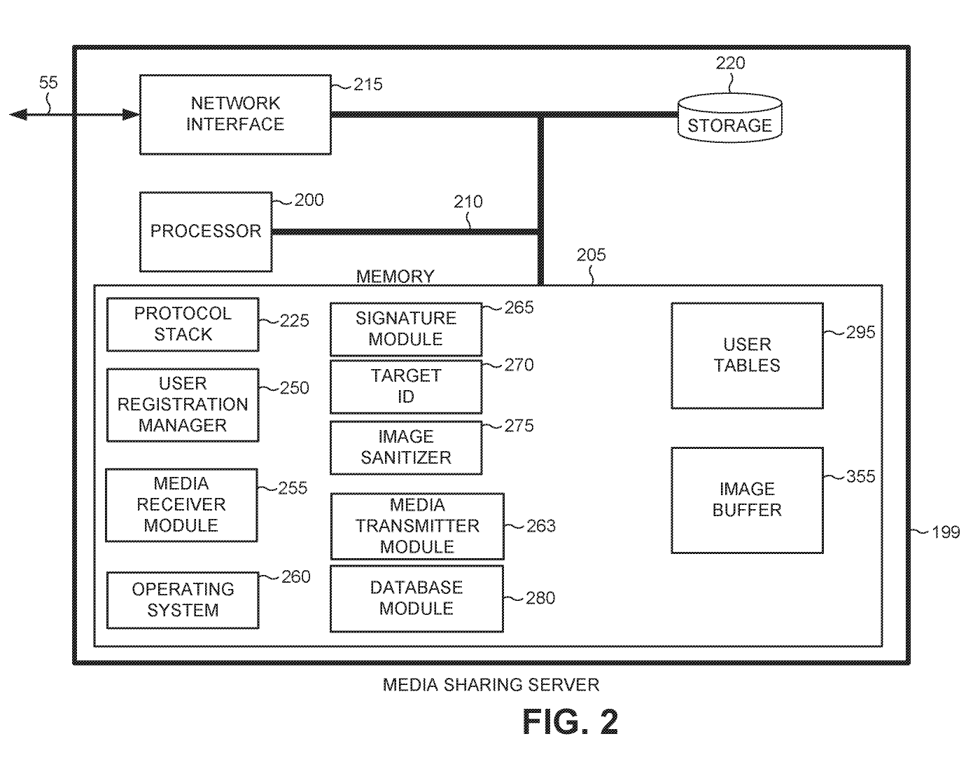

FIG. 2 is a block diagram of one example embodiment of a media-sharing-server included in one example embodiment of a system for sharing media files. In this example embodiment, the media-sharing-server 199 includes a processor 200, a memory 205, an internal bus 210 and a network interface 215. Also included in one alternative example embodiment of a media-sharing-server 199 is a storage device 220 for storing data. In these example embodiments, the processor 200, the memory 205, the network interface 215 and the storage device 220 are all interconnected by way of the internal bus 210, which provides for communications amongst these internal media-sharing-server components.

The media-sharing-server 199 of this example embodiment further includes functional modules stored in the memory 205. The media-sharing-server 199 includes a protocol stack 225, which is stored in the memory 205. This example embodiment of a media-sharing-server 199 also includes a media receiver module 255, a signature module 265, a target identification module 270, and a media transmitter module 263, each of which is stored in the memory 205.

According to one alternative example embodiment, the media-sharing-server 199 also includes a user registration manager 250, which is also stored in the memory 205. The memory 205, according to various illustrative use cases, is used to store user tables 295 and an image buffer 355. These various alternative example embodiments also include a protocol stack 225, which is also stored in the memory 205. An operating system 260 is also stored in the memory 205 included in a media-sharing-server 190. A database module 280 is also included in yet another alternative example embodiment of the media-sharing-server 190 and is stored in the memory 205.

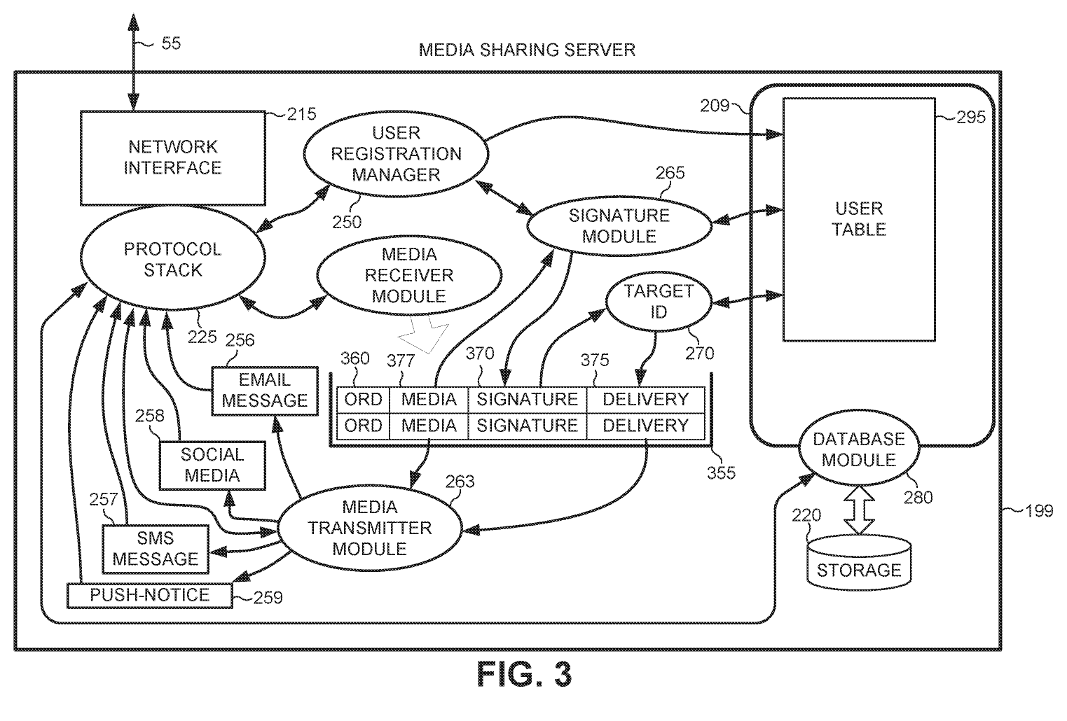

FIG. 3 is a data flow diagram that illustrates the internal operation of various alternative example embodiments of a media sharing server. According to various illustrative use cases, a user uses the multi-media-device 99 to capture at least one or more of a photo, a video, and/or an audio recording. When the user wants to share a multi-media-file, the user sends the multi-media-file to the media-sharing-server 199. This causes the processor 100 in the multi-media-device 99 to request a communications connection the media-sharing-server 199. In response, the processor 200 included in the media-sharing-server 199 executes the protocol stack 225 in order to participate in an upload communication connection, which is initiated by the user's multi-media-device 99.

According to various illustrative use cases, the user sends the multi-media-file to the media-sharing-server 199 using at least one or more of multimedia-message-service, “what's app” instant messaging, Facebook instant messaging, Google instant messaging, Yahoo instant messaging, “LINE” instant messaging, Twitter instant messaging, snap chat instant messaging, and/or Kakoa talk instant messaging. Accordingly, the processor 200 in the media-sharing-server 199 responds to incoming message requests from such various messaging servers. It should be appreciated that such servers including social-messaging-servers. According to another illustrative use case, the user sends a multi-media-file to the media-sharing-server 200 in the form of a email message and, in this case, the media-sharing-server 200 responds to an incoming email. These illustrative use cases are not intended to limit the scope of the claims appended hereto.

The protocol stack 225, when executed by the processor 200, minimally causes the processor 200 to engage in a communications connection using the network interface 215. As already described, the processor 200 responds to an incoming media upload request, which is initiated by a user using a multi-media-device 99, by executing the protocol stack 225. It should be appreciated that, according to various illustrative use case herein described, the processor 200 executes the media receiver module 255 in order to receive a media file from a messaging server by way of a communications connection managed by the processor 200 as the processor 200 continues to execute the protocol stack 225. It should be appreciated that, according to various alternative embodiments, the protocol stack 225, when executed by the processor 200, minimally causes the processor 200 to engage in a communications connection that conforms to the standards of transfer control protocol/Internet protocol (TCP/IP).

As the processor 200 continues to execute the media receiver module 255, the media receiver module 255 further minimally causes the processor 200 to store the received media-file into the memory 205. In one alternative example embodiment, the media receiver module 255, as it is executed by the processor 200, minimally causes the processor 200 to store the media file 377 into a first-in-first-out (FIFO) media buffer 355. It should be appreciated that, according to this example embodiment, the processor 200 manages entries in the FIFO buffer 355 by assigning every entry an ordinal number 360. Management of a FIFO buffer 355 is well known by those skilled in the art.

The processor 200 also executes the signature module 265 when a received media file 377 is stored in the memory 205. The signature module 265, when executed by the processor 200, minimally causes the processor 200 to retrieve a media file 377 stored in the buffer 355, which, according to alternative embodiments, comprises a FIFO buffer. The processor 200, as it continues to execute the signature module 265, is minimally caused to generate a signature according to the media file stored in the memory 205 and to store the signature 370 in association with the media file 377. It should likewise be appreciated that, although this alternative example embodiment of a media-sharing-server 199 relies upon a FIFO buffer 355, management of incoming media files may be accomplished in any manner that appears appropriate to those implementing various techniques and teachings for sharing media files as herein described.

One aspect of the signature module 265 is that, according to one alternative example embodiment, the processor 200, as it continues to execute the signature module 265, searches for a portion of the media file that corresponds with a face. And, in yet another alternative example embodiment, the processor 200 searches for a face located near the center of an image when the media file 377 comprises an image. In this alternative example embodiment, the processor 200 then creates a facial signature, which is stored 370 in association with the media file 377. It should likewise be appreciated that, according to various illustrative use cases that are not intended to limit the scope of the claims appended hereto, the processor 200, as it continues to execute other functional modules herein described, attempts to correlate a facial signature 370 associated with a media file 377 with user records stored in a user table 295, which is stored and maintained by the processor 200 in the memory 205.

The processor 200 also executes the target identification module 270. The processor 200, as it executes the target identification module 270, is minimally caused to correlate the signature 370 associated with the media file 377 with a user record included in the user table 295, which is also stored in the memory 205. In some embodiments, the user table 295 is stored in a special portion of memory known as the database management memory 209.

The database management memory 209 is subject to storage in a storage device 220. This interaction occurs as the processor 200 executes a database module 280, which is included in some of alternative embodiments and stored in the memory 205. The database module 280, as it is executed by the processor 200, minimally causes the processor 200 to ensure that information in the database management memory 209 is synchronized with a permanent database file maintained on the storage device 220. In yet other embodiments, the database module 280, as it is executed by the processor 200, further minimally causes the processor 200 to interact with the protocol stack 225 in order to interact with an external database management system. By interacting with an external database, the processor 200 as it continues to execute the database module 280 maintains synchronization between a database maintained in an external database management system and the data items maintained in the database management memory 209.

When the processor 200, as it executes the target identification module 270, identifies a user record in the user tables 295 that correlates to a signature 370 associated with a media file 377, the processor 200 is further minimally caused to retrieve from the identified user record a delivery indicator and store the delivery indicator 375 in association with media file 377.

Once a delivery indicator 375 has been associated with a media file 377, the processor 200 executes the media transmitter module 263. The media transmitter module 263, when executed by the processor 200, minimally causes the processor to retrieve the media file 377 and the delivery indicator 375 associated therewith and to direct the media file to a user in accordance with the delivery indicator 375. In one example embodiment, the processor does this by executing the protocol stack 225 in order to create a communications channel with a user's multi-media-device 99 in order to affect the transfer of the media file to the user.

FIG. 3 further illustrates that, according to one alternative example embodiment, the media-sharing-server 199 further includes a user registration manager 250 that, when executed by the processor 200, minimally causes the processor to receive into the memory 205 a user registration media file and a destination indicator by way of a registration communications connection. It should be appreciated that the connection is established by the processor 200 as it continues to execute the protocol stack 225. It should likewise be appreciated that the processor executes the protocol stack in response to an incoming connection request, which is received from a user's multi-media-device 99 when the user is engaged in a registration process.

It should be appreciated that, according to various illustrative use case, a user send a “selfie” to the media-sharing-server 200 by way of a messaging server. In response, the processor 200 creates a signature for the user based on the selfie and then stores the signature in association with the messaging return address. The messaging return address then becomes the destination indicator for subsequent media sharing activities. It should likewise be appreciated that, according to various illustrative use cases, the selfie comprises at least one or more of a still image, a video clip and/or an audio clip.

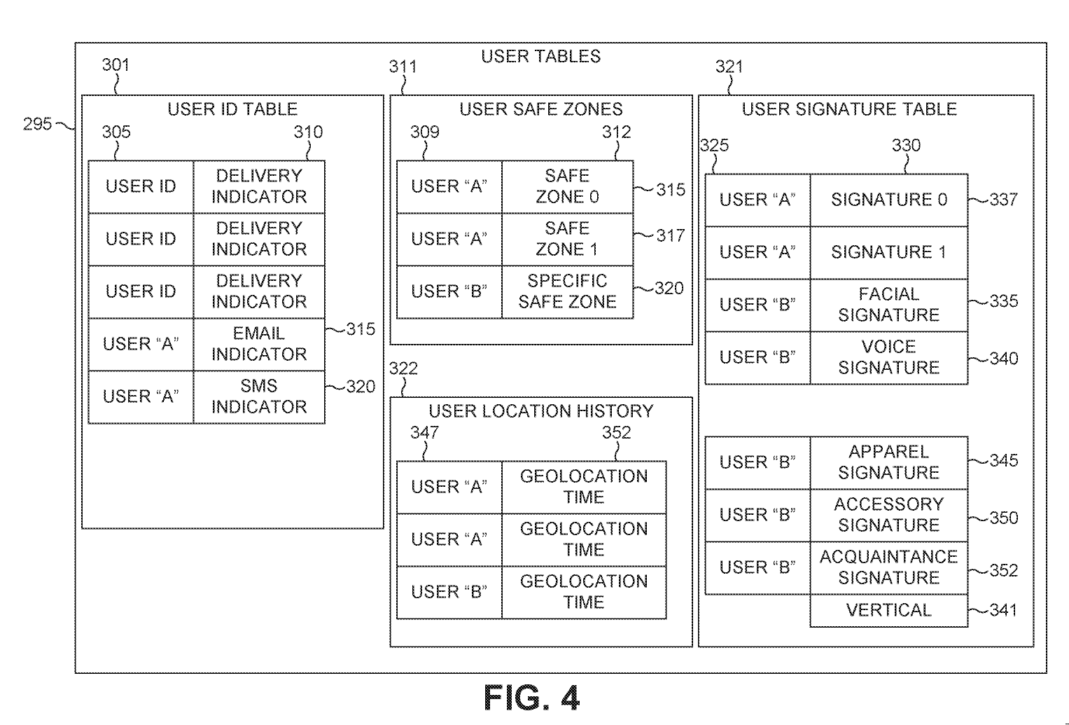

According to this example embodiment, the user registration manager 250, when executed by the processor 200, then directs the user registration media file to the signature module 265. The processor 200 then executes the signature module 265 in order to create a registration signature for a user corresponding to the incoming registration request and stores the registration signature in a user signature table 321 (see 337 in FIG. 4) stored in the memory.

FIG. 4 is a pictorial diagram that depicts alternative example embodiments of user tables maintained by various embodiments of a system for sharing photos. When the user registration manager 250 is executed by the processor 200, the processor creates a new user identifier 305 in a user identifier (ID) table 301 and stores the new user identifier 305 in a new record. The delivery indicator received by the processor as it executes the user registration manager 250 is also stored in a corresponding field 310 in the newly created record. It should likewise be appreciated that, according to one alternative embodiment, the registration manager 250, when executed by the processor, minimally causes the processor 200 to extract from a message received from a messaging server the source-indicator. For example, where a multi-media-file is received from a “whatsapp” server, the whatsapp user identifier associated with the message is extracted and saved as the delivery indicator.

FIG. 4 further illustrates that, as the processor 200 continues to execute the user registration module 250, the processor 200 maintains a user signature table 321 in the memory 205. FIG. 4 presents various illustrative use cases, which are not intended to limit the claims appended hereto. For example, one illustrative use case provides that a first user “USER A” has two registered signatures, “SIGNATURE 0” and “SIGNATURE 1”. It should likewise be appreciated that the user signature table 321 maintained by the processor 200 includes records that correlate back to the user identifier table 301 by a user ID field 305 included in the user ID table 301 and a user ID field 325 included in records stored in the user signature table 321. Records stored in the user signature table 321 include such user identifier field 325 and also include a signature field 330, which is used to store a signature in association with a particular user as specified in the user ID field 325.

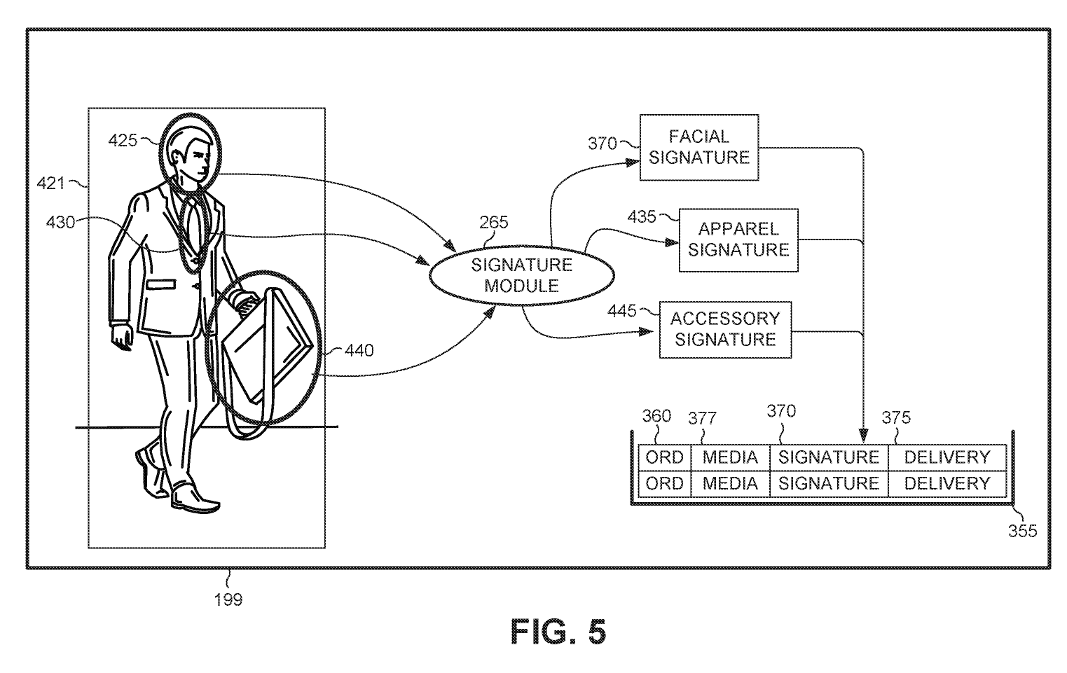

FIG. 5 illustrates the operation of various alternative example embodiments of a signature module. As described in reference to FIG. 4, a signature that is stored in a particular user record may take on various forms. According to one alternative example embodiment, the signature module 265, when executed by the processor 200, minimally causes the processor 200 to retrieve a media file 377 in the form of an image 421. As the processor 200 continues to execute this alternative example embodiment of the signature module 265, the processor 200 further minimally is caused to identify a portion of the image 425 that represents a face. The processor 200, as it continues to execute this alternative example embodiment of the signature module 265, then creates a facial signature 430 and stores the facial signature 430 in association with the media file 377. It should be appreciated that the media file 377 and the associated facial signature 430 are stored by the processor 200 in the memory 205.

FIG. 5 also illustrates that, according to yet another alternative example embodiment, the signature module 265, when executed by the processor 200, minimally causes the processor 200 to retrieve from the memory 205 a media file 377. In this alternative embodiment, the media file 377 also comprises an image 421. According to this alternative example embodiment, the signature module 265, when executed by the processor 200, further minimally causes the processor 200 to identify a portion of the media file that represents at least one or more of an apparel item 430 and/or an accessory item 440. Accordingly, one alternative example embodiment of the signature module 265, when executed by the processor 200, further minimally causes the processor 200 to create a signature for an apparel item 435. In yet another alternative example embodiment of the signature module 265, the processor 200 creates an accessory signature 445 as it continues to execute the signature module 265. In either case, the signature is then stored in the memory 205 in association with the media file 377.

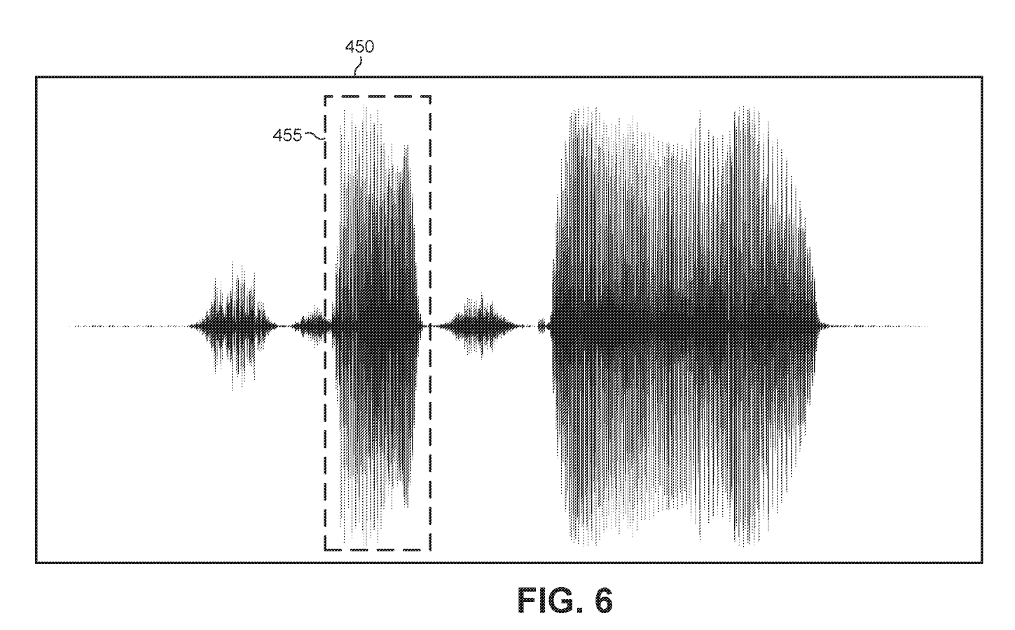

FIG. 6 is a pictorial diagram that illustrates the operation of yet another alternative example embodiment of a signature module that operates on an audio clip. According to this alternative example embodiment of a signature module 265, the signature module 265, when executed by the processor 200, minimally causes the processor 200 to retrieve a media file 377 from the memory 205. In this particular alternative embodiment, the form of the media file 377 comprises an audio clip 450. As the processor 200 executes this alternative example embodiment of the signature module 265, the processor 200 further minimally is caused to identify a portion of the media file 377 that corresponds to human speech 455. The processor 200, as it continues to execute this alternative example embodiment of the signature module 265, creates a signature according to the identified portion 455 of the media file 377 and then stores the signature 370, which is in the form of a speech recognition signature, in the memory 205 in association with the media file 377.

It should be appreciated that, according to various illustrative use cases and various alternative example embodiments of the signature module 265, the signature module 265, when executed by the processor 200, causes signatures to be created based on a plurality of media file formats. For example, when a media file comprises a video clip, the signature module 265 of one alternative embodiment causes the processor 200 to create signatures based on images captured from the video clip. In another example, when a media file comprises a video clip, the signature module 265 of yet another alternative example embodiment causes the processor to create a voice recognition signature. Accordingly, a video clip, which is just one illustrative use case, requires that the signature module 265 of the various alternative embodiments be applied to the creation of signatures for various aspects of recognizable elements within the video clip. It should likewise be appreciated that such illustrative use cases herein presented are intended to enhance comprehension of the disclosure set forth herein and are not intended to limit the scope of the claims appended hereto.

FIGS. 3 and 4 further illustrate that, according to one alternative example embodiment, the target identification module 270, when executed by the processor 200, causes the processor 200 to retrieve from the memory 205 a signature 370 associated with a received media file 377. The target identification (ID) module 270, as it is further executed by the processor 200, further minimally causes the processor 200 to identify a user record by comparing the retrieved signature 370 with a registration signature 337 stored in the user signature table 321. It should be appreciated that, according to various illustrative use cases, the registration signature 337 is merely an initial facial signature that is stored in the user signature table 321 when a user registers with the system herein described. As the system continues to operate, users represented in the user identification table 301 are associated with additional signatures as herein described. As this alternative example embodiment of the target identification module 270 is further executed by the processor 200, the processor 200 then retrieves a delivery indicator 310 from the user identification table 301 associated with a particular user according to user identifier 305 and stores the delivery indicator 375 in association with the received media file 377.

FIGS. 3 and 4 also illustrate that, according to yet another alternative example embodiment, the target identification module 270, when executed by the processor 200, retrieves a media file 377 from the memory 205 and also retrieves a signature associated with the media file. It should be appreciated that a signature associated with a media file 377 is intended to be a facial signature that is used for correlating with registration signatures 337 stored in the user signature table 321. However, this alternative example embodiment of the target identification module 270, when executed by the processor 200, need not be limited to correlation with a registration signature 337, but rather uses all signatures associated with a particular user as stored in the user signature table 321.

FIGS. 3 and 4 illustrate that, according to yet another alternative example embodiment, the target identification module 270, when executed by the processor 200, causes the processor 200 to retrieve from the memory 205 a signature associated with a received media file 377 and to identify a user record by correlating the retrieved signature (i.e. the signature 370 associated with the received media file 377) to signatures stored in the signature table 321 included in the user tables 295. The processor 200, as it continues to execute this alternative example embodiment of a target identification module 270, retrieves a delivery indicator 310 from the user identification table 301 for the identified user record. The processor 200 then stores the delivery indicator 310 in the memory 205, again in association with the received media file 377.

It should likewise be appreciated that the signature module 265 of one alternative example embodiment, when executed by the processor, minimally causes the processor to create a signature that is associated with a portion 410 of the received media file 377. As such, the portion 410 of the received media file is associated with a particular user record 405. Such association is accomplished as the processor 200 executes the Target ID module 270, that, when executed by the processor, minimally causes the processor to correlate the signature corresponding to a portion 410 of a received media file 377 with signatures included in the user table 295. According to such correlation, a user record stored in the memory 205 is identified according to the signature corresponding to a portion 410 of the received media file 377. It should likewise be appreciated that, the received media file 377, according to one illustrative use case, comprises an image 380.

FIG. 3 further illustrates that, according to one alternative example embodiment, the media transmitter module 263, when executed by the processor 200, minimally causes the processor 200 to retrieve from the memory 205 a delivery indicator 375 that is associated with a received media file 377. It should be appreciated that, according to various illustrative use cases and embodiments herein described, the target identification module 270, when executed by the processor 200, correlates a signature 370 associated with a received media file 377 with signatures stored in the user tables 295 in order to identify a particular user associated with the received media file 377. Once a particular user is identified, a delivery indicator is retrieved from the user tables 295 and stored by the processor 200, as it executes the target identification module 270, in a delivery indicator 375 memory location 205 associated with the received media file 377.

The media transmitter module 263 of this alternative example embodiment, when executed by the processor 200, further minimally causes the processor 200 to create an email message 256 in the memory 205 and addresses the email message according to the delivery indicator 375, which is in the form of an email address. The media transmitter module 263 of this alternative example embodiment further minimally causes the processor 200 to attach the received media file 377 to the email message 256 and then execute the protocol stack 225 in order to establish a media-sharing communications connection with an email server and convey the email message 256 from the memory 205 to the email server using the established media-sharing communications connection.

FIG. 3 also illustrates that, according to yet another alternative example embodiment of a media transmitter module 263, the processor 200, as it executes this alternative example embodiment of the media transmitter module 263 is minimally caused to retrieve from the memory 205 a delivery indicator 375, in the form of a multimedia-message-service target-identifier, that is associated with the received media file 377.

As the processor 200 continues to execute this alternative example embodiment of a media transmitter module 263, it is further minimally caused to create a short-message 257 in the memory 205 and attach the media file 377 to the short-message. The processor 200 further is caused to execute the protocol stack 225 in order to establish a media-sharing communications connection with a short-message-delivery-server. The processor 200 is further minimally caused to convey to the short-message-delivery-server, using the established media-sharing communications connection, the short-message that it created as it continued execution of this alternative example embodiment of a media transmitter module 263.

In yet another alternative example embodiment, the media transmitter module 263, as it is executed by the processor 200, minimally causes the processor 200 retrieve from the memory 205 a social media delivery descriptor that is associated with a received media file 377. The media transmitter module 263 of this alternative embodiment further minimally causes the processor 200 to create a social media delivery message 258 and execute the protocol stack 225 in order to establish a media-sharing communications connection with a social media system and convey the social media delivery message 258 to said social media system using the established media-sharing communications connection.

It should be appreciated that, according to various illustrative use cases, the processor 200 included in the media-sharing-server 199 creates various forms of social media delivery messages which are compatible with at least one or more of an application called “what's app”, a social media platform known as Facebook, a messaging platform called Skype, and/or a messaging system called Slack. These illustrative use cases that are presented here in order to help a reader comprehend the notion of a social media delivery message and these illustrative use cases are not intended to limit the scope of the claims appended hereto.

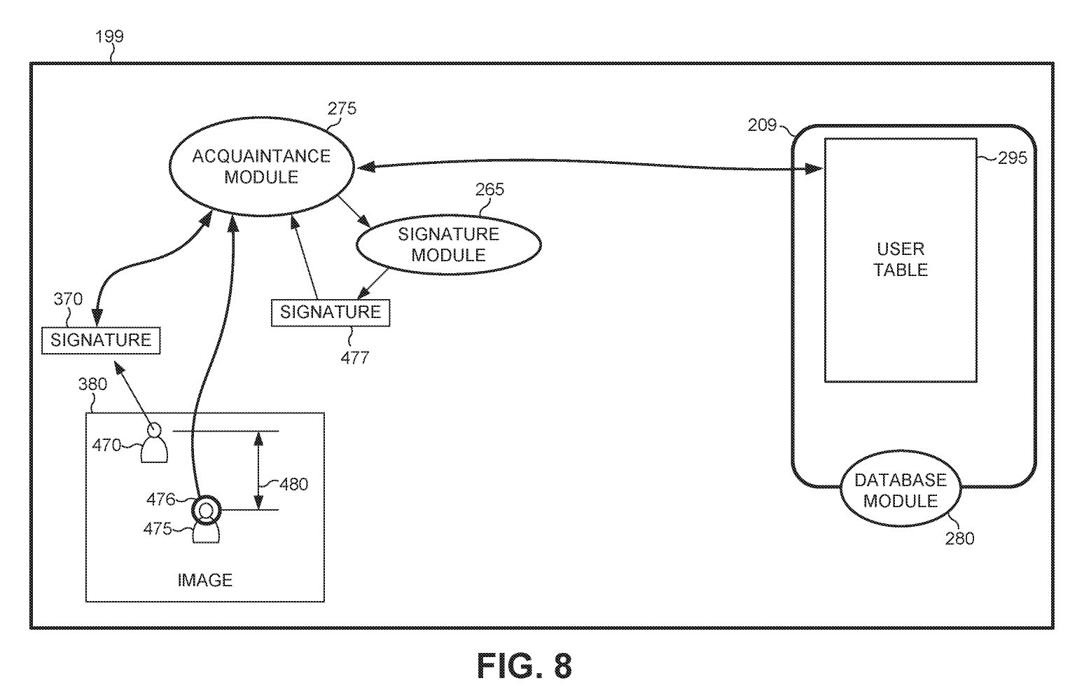

FIG. 8 is a data flow diagram that depicts the operation of the processor as it executes one example embodiment of an acquaintance module. It should be appreciated that, according to various illustrative embodiments, a system for sharing a media file 199 further includes an acquaintance module 275, which is stored in the memory 205. When executed by the processor 200, the acquaintance module 275 minimally causes the processor 200 to retrieve from the memory 205 a received media file 377. According to some illustrative use cases, the media file retrieved from the memory 205 comprises an image 380.

Associated with the media file 377 is a signature 370. Using the signature 370 associated with the media file 377, the processor 200, as it further executes this alternative embodiment of an acquaintance module 275, identifies a first user record in a user table 295 stored in the memory 205. A portion of the media file 377 that corresponds to a second facial image 476 is then identified and the signature module 265 is executed in order to create a signature 477 according to the second facial image. The processor 200, as it continues to execute the acquaintance module 275, then stores the signature for the second facial image in the user tables 295 in association with the identified first user record.

According to one alternative example embodiment, the acquaintance module 275, as it is further executed by the processor 200, further minimally causes the processor 200 to determine a vertical offset 480 between the signature image 470 and the secondary facial signature image 476. The vertical offset is stored in the user tables 295, according to one alternative embodiment in a vertical offset field 341 as shown in FIG. 4. In this manner, it is possible to determine a relative height between a first subject, e.g. signature 370, and an acquaintance of the first subject identified by signature 477 as a result of executing the signature module 265 upon that portion 476 of the media file 377 that corresponds to a second facial image. This information is used, according to another alternative embodiment, to further enhance the efficacy of a learning mechanism described below.

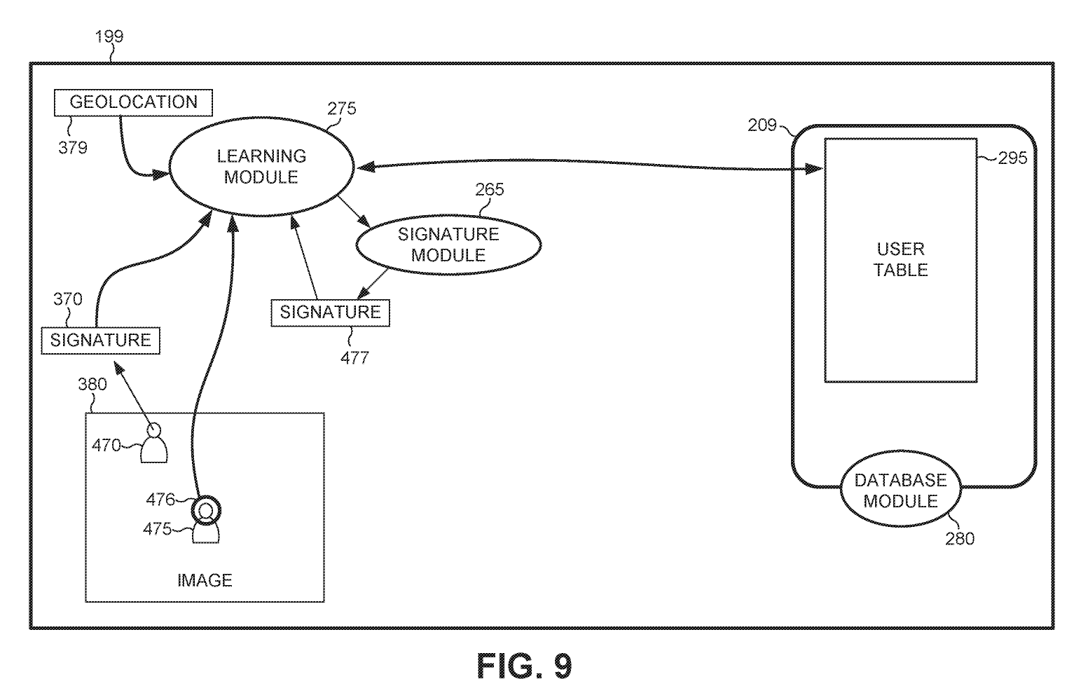

FIG. 9 is a data flow diagram that depicts the operation of the processor when executing one example embodiment of a learning module. According to one example embodiment, the system for sharing a media file further includes a learning module 275, which is stored in the memory 205. When the processor 200 executes the learning module 275, the processor 200 is minimally caused to retrieve a received media file 377 from the memory 205 along with an associated facial signature 370. It should be appreciated that, according to one illustrative use case, the media file 377 comprises an image 380. According to this example embodiment, the processor 200, as it continues to execute the learning module 275, is further minimally caused to identify a user record in the user table 295 according to an approximate match of the facial signature 370 associated with the received media file 377.

Working upon the media file 377, the processor 200, as it continues to execute this example embodiment of a learning module 275, identifies a portion of the media file 377 that is associated with a second facial image 476. The learning module 275, as further executed by the processor 200, further minimally causes the processor 200 to execute the signature module 265 in order to create a signature 477 according to the identified portion 476 of the media file 377.

The processor 200, as it continues to execute this example embodiment of a learning module 275, correlates the created signature 477 with secondary facial signatures associated with the identified user record stored in the user tables 295, said user tables 295 being stored in the memory 205. If such correlation is achieved, that is to say that the signature 477 created by the processor 200 by executing the signature module 265 and using as an input the portion 476 of the media file 377 that corresponds to a second facial image, then the processor 200, as it continues to execute the learning module 275, will store the signature 370 associated with the media file as a secondary facial signature in the identified user record stored in the user table 295, said user tables being stored in the memory 205. In this way, slight variations of facial signatures for a particular user are catalogued in the user tables 295 in an automatic manner based on a secondary indicator, that being of an acquaintance of a user identified by a partial match of the signature 370 associated with the media file 377. In one alternative embodiment, the processor 200, as it executes the learning module 275, also uses a vertical offset 341 associated with an acquaintance signature 352 (see FIG. 4) in order to provide additional fidelity to the learning process.

FIG. 9 also illustrates that the learning module 275 of one alternative example embodiment, when executed by the processor 200, minimally causes the processor to use a signature 370 associated with a received media file 377 in order to identify a user within the user tables 295. When such user identification is accomplished by a partial or approximate match, this alternative example embodiment of the learning module 275 retrieves location history information for a particular user, as identified by the approximate match to the signature 370 associated with the received media file 377, and attempts to correlate a signature 370 that is a partial match to a particular identified user record with the geolocation at which a particular received media file 377 is captured. Upon such correlation, the processor 200, as it continues to execute this alternative example embodiment of the learning module 275, stores the signature 370 associated with a received media file 377 as a secondary facial signature for a particular user.

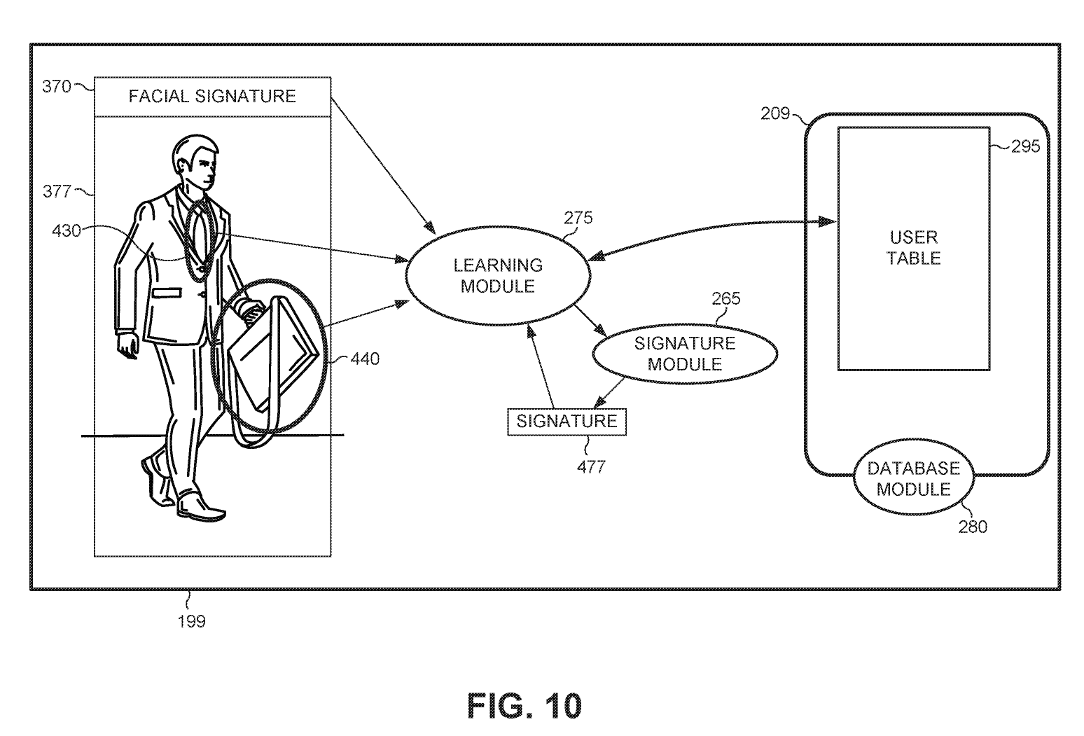

FIG. 10 is a data flow diagram that depicts the operation of the processor as it executes an alternative embodiment of the learning module. Just as the processor 200, as it executed one example of the learning module 275, use a secondary facial image in a media file 377 to associate a partial matching facial signature with a user, the processor 200, as it executes this alternative example embodiment of the learning module 275 uses other secondary indicators, for example at least one or more of an apparel signature and/or an accessory signature.

According to one alternative example embodiment, the processor 200, as it executes the learning module 275, uses the facial signature 370 stored in association with a received media file 377 in order to achieve a partial match with a particular user record stored in the user table 295. Accordingly, the learning module of this alternative example embodiment, when executed by the processor 200, further minimally causes the processor 200 to retrieve the received media file 377 from the memory 205 and to identify a portion of the media file associated with an apparel item 430. The learning module 275, as further executed by the processor 200, further minimally causes the processor 200 to execute the signature module 265 in order to create a signature 477 according to the portion of the media file associated with an apparel item 430.

The processor 200, as it continues to execute this alternative example embodiment of the learning module 275, attempts to correlate the created signature with an apparel signature associated with the identified user record. If such correlation is achieved, then the facial signature 370, which was used to achieve a partial match with a particular user record, is then stored in the identified user record as a secondary facial signature.

It should likewise be appreciated that, according to yet another alternative example embodiment of the learning module 275, this process is applied to a portion of the media file 377 that is associated with an accessory item 440. Accordingly, if the accessory item 440 depicted in the media file 377 can be correlated with an accessory signature stored in the identified user record, then the facial signature 370 associated with the received media file 377 is stored in the identified user record as a secondary facial signature for that particular identified user record.

The functional processes (and their corresponding instruction sequences) described herein enable a processor to share media in accordance with the techniques, processes and other teachings of the present method. According to one alternative embodiment, these functional processes are imparted onto computer readable medium. Examples of such medium include, but are not limited to, random access memory, read-only memory (ROM), Compact Disk (CD ROM), Digital Versatile Disks (DVD), floppy disks, flash memory, and magnetic tape. This computer readable medium, which alone or in combination can constitute a stand-alone product that can be used to convert a general or special purpose computing platform into an apparatus capable of sharing media according to the techniques, processes, methods and teachings presented herein. Accordingly, the claims appended hereto are to include such computer readable medium imparted with such instruction sequences that enable execution of the present method and all of the teachings herein described.

Aspects of the method and apparatus described herein, such as the logic, may also be implemented as functionality programmed into any of a variety of circuitry, including programmable logic devices (“PLDs”), such as field programmable gate arrays (“FPGAs”), programmable array logic (“PAL”) devices, electrically programmable logic and memory devices and standard cell-based devices, as well as application specific integrated circuits. Some other possibilities for implementing aspects include: memory devices, microcontrollers with memory (such as electrically erasable programmable read-only memory i.e “EEPROM”), embedded microprocessors, firmware, software, etc. Furthermore, aspects may be embodied in microprocessors having software-based circuit emulation, discrete logic (sequential and combinatorial), custom devices, fuzzy (neural) logic, quantum devices, and hybrids of any of the above device types.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A system for sharing a media file comprising:
media-sharing-server comprising:
internal bus for communicating information with the media-sharing-server;
network interface for communicating with a communications network, said network interface begin attached to the internal bus;
processor for executing instructions, said processor begin attached to the internal bus;
memory for storing data and instruction sequences, said memory begin attached to the internal bus;
one or more functional modules stored in the memory including:
protocol stack that, when executed by the processor in response to a received upload request, minimally causes the processor to engage in a communication connection using the network interface;
media receiver module that, when executed by the processor, minimally causes the processor to execute the protocol stack in order to receive a media file into the memory by way of communication connection;
signature module that, when executed by the processor, minimally causes the processor to generate a signature according the media file stored in the memory and story the signature in the memory in association with the media file;
target identification module that, when executed by the processor, minimally causes the processor to:
correlate the signature associated with the media file with a user record included in a user table stored in the memory;
retrieve from the user table a user destination identifier according to the correction; and
store the destination identifier in the memory in association with the media file;
media transmitter module that, when executed by the processor, minimally causes the processor to:
execute the protocol stack in order to direct the media file from the memory to the network interface according to the user destination identifier associated therewith.

2. The system of claim 1 wherein the media receiver module, when executed by the processor, minimally causes the processor to:
execute the protocol stack in response to receiving by way of the network interface a message from a multimedia-message-service server, said message including a media file;
extract the media file from the message; and
store the message in the memory.

3. The system of claim 1 wherein the media receiver module, when executed by the processor, minimally causes the processor to:
execute the protocol stack in response to receiving by way of the network interface a message from an email server, said message including a media file;
extract the media file from the message; and
store the message in the memory.

4. The system of claim 1 wherein the media receiver module, when executed by the processor, minimally causes the processor to:
execute the protocol stack in response to receiving by way of the network interface a message from a messaging system server, said message including a media file;
extract the media file from the message; and
store the message in the memory.

5. The system of claim 1 wherein the media receiver module, when executed by the processor, minimally causes the processor to:
execute the protocol stack in response to receiving a message by way of the network interface from a social-media server, said message including a media file;
extract the media file from the message; and
store the message in the memory.

6. The system of claim 1 further comprising a user registration manager, stored in the memory of the media-sharing-server, and that, when executed by the processor, minimally causes the processor to:
receive into the memory of the server a user registration media file and a destination indicator by way of a registration communication connection, said connection established by the processor by executing the protocol stack in response to an incoming connection request;
execute the signature module in order to cause the processor to create a signature according the user registration media file; and
store in the memory the signature in association with the destination indicator.

7. The system of claim 6 wherein the user registration manager, stored in the memory of the media-sharing-server, when executed by the processor, further minimally causes the processor to receive into the memory a destination indicator by way of a registration communication connection by minimally causing the processor to:
extract from the message a message-source-identifier in the form of a multimedia-message-service phone number; and
store as a destination identifier the message-source-identifier in the memory in association with the signature.

8. The system of claim 6 wherein the user registration manager, stored in the memory of the media-sharing-server, when executed by the processor, further minimally causes the processor to receive into the memory a destination indicator by way of a registration communication connection a by minimally causing the processor to:
extract from the message a message-source-identifier in the form of a return email address; and
store as a destination identifier the message-source-identifier in the memory in association with the signature.

9. The system of claim 6 wherein the user registration manager, stored in the memory of the media-sharing-server, when executed by the processor, further minimally causes the processor to receive into the memory a destination indicator by way of a registration communication connection a by minimally causing the processor to:
extract from the message a message-source-identifier in the form of a social-media user identifier; and
store as a destination identifier the message-source-identifier in the memory in association with the signature.

10. The system of claim 1 wherein the signature module, when executed by the processor, minimally causes the processor to create a signature by causing the processor to:
retrieve a media file from the memory;
identify a portion of the media file that represents a face;
create a signature according to the identified portion of the media file; and
save the signature in the memory in association with the media file.

11. The system of claim 1 wherein the signature module, when executed by the processor, minimally causes the processor to create a signature by causing the processor to:
retrieve a media file from the memory;
identify a portion of the media file that represents an apparel item;
create a signature according to the identified portion of the media file; and
save the signature in the memory in association with the media file.

12. The system of claim 1 wherein the signature module, when executed by the processor, minimally causes the processor to create a signature by causing the processor to:
retrieve a media file from the memory;
identify a portion of the media file that represents an accessory item;
create a signature according to the identified portion of the media file; and
save the signature in the memory in association with the media file.

13. The system of claim 1 wherein the signature module, when executed by the processor, minimally causes the processor to create a signature by causing the processor to:
retrieve a media file from the memory;
identify a portion of the media file that corresponds to human speech;
create a signature according to the identified portion of the media file; and
save the signature in the memory in association with the media file.

14. The system of claim 1 wherein the target identification module, when executed by the processor, further minimally causes the processor to:
retrieve from the memory a signature associated with a received media file;
identify a user record by comparing the retrieved signature with a registration signature stored in a user record stored in the memory;
retrieve from the memory a delivery indicator stored in the identified user record; and
store in the memory the delivery indicator in association with the media file.

15. The system of claim 1 wherein the target identification module, when executed by the processor, further minimally causes the processor to:
retrieve a media file from the memory;
retrieve from the memory a signature associated with the media file;
identify a user record by comparing the retrieved signature with a signature stored in a user record stored in the memory;
identify a first portion of the media file that represents a face;
identify a second portion of the media file that represents at least one or more of an apparel item and/or an accessory item that is associated with the face;
execute the signature module to create a signature according to the second identified portion of the media file; and
save in the memory in association with the identified user record the signature of at least one or more of an apparel item and/or an accessory item.

16. The system of claim 1 wherein the target identification module, when executed by the processor, further minimally causes the processor to:
retrieve from the memory a signature associated with the media file;
identify a user record by comparing the retrieved signature with a signature stored in a user record stored in the memory;
retrieve from the memory a delivery indicator stored in the identified user record; and
store in the memory the delivery indicator in association with the media file.

17. The system of claim 1 wherein the media transmitter module, when executed by the processor, minimally causes the processor to:
retrieve from the memory a destination indicator in the form of an email address, wherein said destination indicator has been associated with a received media file;
create an email message in the memory according to the email address;
attach the media file stored in the memory to the email message;
execute the protocol stack in order to establish a media-share communication connection with an email server; and
convey the email message from the memory to the email server using the media-share communication connection.

18. The system of claim 1 wherein the media transmitter module, when executed by the processor, minimally causes the processor to:
retrieve from memory a delivery indicator in the form of a multimedia-message-service target-identifier, said delivery indicator associated with a received media file;
create a multimedia-message in the memory according to the delivery indicator;
attach the media file stored in the memory to the short message;
execute the protocol stack in order to establish a media-share communication connection with a multimedia-message-delivery server; and
convey the multimedia-message from the memory to the multimedia-message-delivery server using the media-share communication connection.

19. The system of claim 1 wherein the media transmitter module, when executed by the processor, minimally causes the processor to:
retrieve from memory a delivery indicator in the form of a social-media-target-identifier, said delivery indicator associated with a received media file;
create a social-media-delivery-message in the memory according to the delivery indicator;
attach the media file stored in the memory to the social-media-delivery-message;
execute the protocol stack in order to establish a media-share communication connection with a social media server; and
convey the social-media-delivery-message from the memory to the social media server using the media-share communication connection.

20. The system of claim 1 further comprising an acquaintance module stored in the memory of the media-sharing-server that, when executed by the processor, minimally causes the processor to:
retrieve a received media file from the memory, said media file having associated therewith one facial signature;
identify a user in a user table stored in the memory according to a facial signature associated with the received media file;
identify a portion of the media file associated with a second facial image;
execute the signature module to create a second facial signature according to the identified portion of the media file; and
store in the user table in association with the identified user the second facial signature.

21. The system of claim 1 further comprising a learning module stored in the memory of the media-sharing-server that, when executed by the processor, minimally causes the processor to:
retrieve a received media file from the memory, said media file having associated therewith one facial signature;
identify a user record in a user table stored in the memory according to an approximate match to the facial signature associated with the received media file;
identify a portion of the media file associated with a second facial image;
execute the signature module to create an acquaintance signature according to the identified portion of the media file; and
store in the identified user record the facial signature associated with the received media file when the identified user record includes a signature that corresponds to the second facial signature.

22. The system of claim 1 further comprising a learning module stored in the memory of the media-sharing-server that, when executed by the processor, minimally causes the processor to:
retrieve a received media file from the memory, said media file having associated therewith one facial signature;
identify a user record in a user table stored in the memory according to an approximate match to the facial signature included in the received media file;
identify a portion of the media file associated with an apparel item;
execute the signature module to create an apparel signature according to the identified portion of the media file; and
store in the identified user record the facial signature included in the received media file when the identified user record includes a signature that corresponds to the apparel signature.

23. The system of claim 1 further comprising a learning module stored in the memory of the media-sharing-server that, when executed by the processor, minimally causes the processor to:
retrieve a received media file from the memory, said media file having associated therewith one facial signature;
identify a user record in a user table stored in the memory according to an approximate match to the facial signature included in the received media file;
identify a portion of the media file associated with an apparel item;
execute the signature module to create an accessory signature according to the identified portion of the media file; and
store in the identified user record the facial signature included in the received media file when the identified user record includes a signature that corresponds to the accessory signature.
